(19) United States
(12) Patent Application Publication
(10) Pub. No.: US 2021/0225563 A1
(43) Pub. Date: Jul. 22, 2021

(54) SHUNT RESISTOR AND SHUNT RESISTOR MOUNTING STRUCTURE

(71) Applicant: KOA CORPORATION, Ina-shi, Nagano (JP)

(72) Inventor: Tamotsu ENDO, Nagano (JP)

(21) Appl. No.: 17/259,856

(22) PCT Filed: Jul. 1, 2019
(86) PCT No.: PCT/JP2019/026179

§ 371 Date: Jan. 12, 2021

(30) Foreign Application Priority Data
Jul. 17, 2018 (JP) 2018-134234

(51) Int. Cl. H01C 1/14; H01C 1/01

(52) U.S. Cl. CPC H01C 1/14; H01C 1/01

(57) ABSTRACT

This shunt resistor includes: a first terminal and a second terminal each made of an electrically conductive metal material and having a first planar surface and a second planar surface, the respective first planar surfaces of the first terminal and the second terminal opposing each other; and a resistive body and a support column member each connected to the respective first planar surfaces and connecting the first terminal and the second terminal. The support column member is made of a metal material. An area of bonding between the resistive body and the support column member and the respective first planar surfaces is smaller than an area of the first planar surface. The first terminal and the second terminal each have a hole portion formed so as to penetrate therethrough from the first planar surface to the second planar surface.

### RELATED APPLICATIONS

This application is a 371 application of PCT/JP2019/026179 having an international filing date of Jul. 1, 2019, which claims priority to JP 2018-134234 filed Jul. 17, 2018, the entire content of each of which is incorporated herein by reference.

### TECHNICAL FIELD

The present invention relates to a shunt resistor and a shunt resistor mounting structure.

### BACKGROUND ART

For example, a shunt resistor is used to detect an electric current in a semiconductor power module or the like mounted on an electric vehicle. Patent Literature 1 describes a shunt resistor that can be attached easily, does not require too much attachment space, and is capable of performing highly accurate current detection.

The shunt resistor described in Patent Literature 1 is provided with a first terminal and a second terminal, each of which is made of an electrically conductive metal material and has a first planar surface, a second planar surface, and an outer peripheral surface around the planar surfaces, the respective first planar surfaces of the first terminal and the second terminal opposing each other; and a resistive body connected to the respective first planar surfaces and connecting the first terminal and the second terminal. The area of bonding between the resistive body and the respective first planar surfaces is smaller than the area of the first planar surface. The first terminal and the second terminal each have a hole portion formed so as to penetrate therethrough from the first planar surface to the second planar surface. In the following, a shunt resistor of such structure may be referred to as a “shunt (resistor)”.

### CITATION LIST

### Patent Literature

Patent Literature 1: JP 2017-212297 A

### SUMMARY OF INVENTION

### Technical Problem

The shunt resistor described in Patent Literature 1 is structured such that an output signal voltage lead-out terminal is led out from the side of each of the first terminal and the second terminal. In the shunt, the resistance value can be adjusted by adjusting the diameter or length of the resistor, which provides a support column.

However, if the diameter of the support column is too small, the connection (bonding) strength with the electrodes decreases. Further, if the length of the support column is increased, there is the problem of difficulty in reducing the size of the resistor. That is, when it is desired to increase the resistance value of the shunt resistor, the problem of difficulty in achieving both strength and size reduction arises. In addition, when voltage detection signals are connected to a substrate, it is difficult to reduce the size of a wiring loop composed of two detection signals. Thus, there is the problem of susceptibility to the influence of the noise of induced electromotive force generated by a magnetic flux due to an electric current being measured.

The purpose of the present invention is to solve the aforementioned problems.

### Solution to Problem

According to an aspect of the present invention, there is provided a shunt resistor including: a first terminal and a second terminal each made of an electrically conductive metal material and having a first planar surface and a second planar surface, the respective first planar surfaces of the first terminal and the second terminal opposing each other; and a resistive body and a support column member each connected to the respective first planar surfaces and connecting the first terminal and the second terminal, the support column member being made of a metal material. An area of bonding between the resistive body and the support column member and the respective first planar surfaces is smaller than an area of the first planar surface. The first terminal and the second terminal each have a hole portion formed so as to penetrate therethrough from the first planar surface to the second planar surface.

Preferably, an insulating substrate may be interposed between the support column member and the first terminal or the second terminal. The support column member is able to output voltage signals of the first terminal and the second terminal. The insulating substrate may have a wiring pattern, and the support column member and the wiring pattern may be connected. The support column member may have a screw structure. In this case, not only the first planar surface but also the second planar surface may be provided with a screw receiving portion. A fixing means penetrating through the hole portions and fixing the first terminal and the second terminal together may be provided.

The description includes the contents disclosed in JP Patent Application No. 2018-134234 to which the present application claims priority.

### Advantageous Effects of Invention

According to the present invention, it is possible to reduce the size of the resistor.

Further, according to the present invention, it is possible to achieve both strength and size reduction of the resistor.

Further, according to the present invention, it is possible to suppress the influence of the noise of induced electromotive force generated by a magnetic flux due to an electric current being measured.

### BRIEF DESCRIPTION OF DRAWINGS

FIG. 1AA is an exploded perspective view of a shunt resistor according to a first embodiment of the present invention, FIG. 1AB is a front surface view of a substrate, and FIG. 1AC is a back surface view of the substrate.

FIG. 1B is a perspective view of the shunt resistor.

FIG. 2A illustrates a shunt resistor manufacturing step.

FIG. 2B illustrates a shunt resistor manufacturing step.

FIG. 2C illustrates a shunt resistor manufacturing step.

FIG. 2D illustrates a shunt resistor manufacturing step.

FIG. 2E illustrates a shunt resistor manufacturing step in which a mounting structure has been manufactured.

FIG. 3A is an exploded perspective view illustrating a shunt resistor mounting structure.

FIG. 3B is a perspective view illustrating a shunt resistor mounting structure.

FIG. 4A is a perspective view illustrating a configuration in which a shunt resistor according to a second embodiment of the present invention is attached to a mounting substrate, as viewed from diagonally above.

FIG. 4B is a perspective view illustrating the configuration in which the shunt resistor according to the second embodiment of the present invention is attached to the mounting substrate, as viewed from above.

FIG. 4C is a cross sectional view illustrating the configuration in which the shunt resistor according to the second embodiment of the present invention is attached to the mounting substrate.

FIG. 5 is a perspective view of the configuration in which the shunt resistor according to the present embodiment is attached to the mounting substrate, as viewed from diagonally below.

FIG. 6A is an exploded perspective view illustrating a configuration example of a shunt resistor according to a third embodiment of the present invention.

FIG. 6B is a perspective view of the shunt resistor according to the third embodiment of the present invention.

FIG. 7A is an exploded perspective view illustrating a configuration example of a shunt resistor according to a fourth embodiment of the present invention.

FIG. 7B is a perspective view of the shunt resistor according to the fourth embodiment of the present invention.

### DESCRIPTION OF EMBODIMENTS

In the following, the shunt resistor according to embodiments of the present invention will be described with reference to the drawings.

### First Embodiment

First, a first embodiment of the present invention will be described.

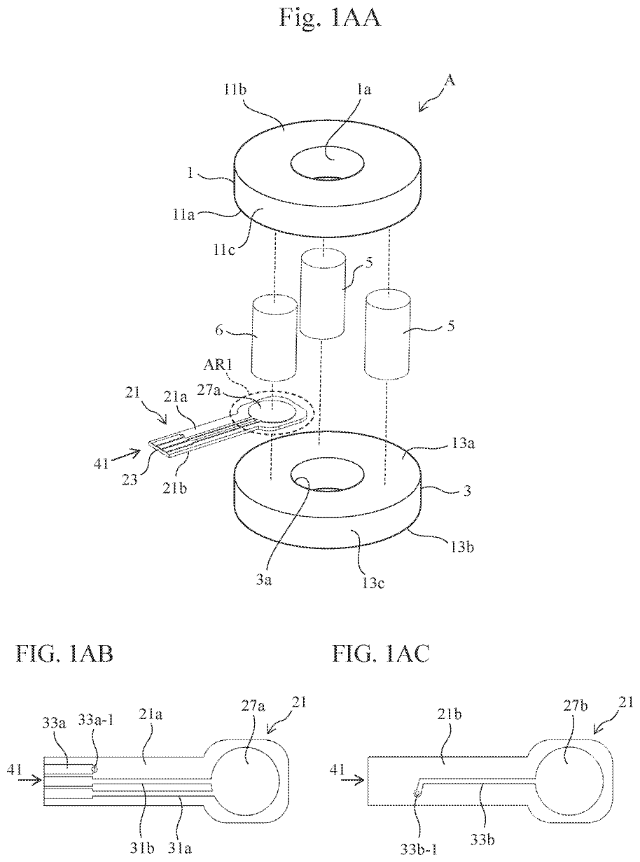

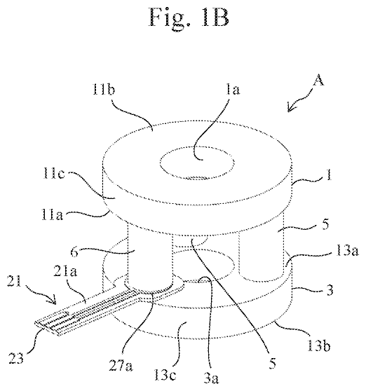

FIG. 1AA is an exploded perspective view of the shunt resistor according to the present embodiment, and FIG. 1B is a perspective view of the shunt resistor. FIGS. 1AB and 1AC illustrate a front surface view and a back surface view of a substrate, as will be described below. As illustrated in FIGS. 1AA, 1AB and 1AC, and FIG. 1B, the shunt resistor A according to the present embodiment includes terminals (electrodes) and resistive bodies. A first terminal 1 and a second terminal 3 are made of an electrically conductive metal material. The first terminal 1 includes a first planar surface 11a and a second planar surface 11b, and an outer peripheral surface 11c around the planar surfaces. The second terminal 3 includes a first planar surface 13a and a second planar surface 13b, and an outer peripheral surface 13c around the planar surfaces.

The respective first planar surfaces 11a, 13a of the first terminal 1 and the second terminal 3 are opposed to each other. The respective first planar surfaces 11a, 13a are connected with resistive bodies 5, 5 connecting the first terminal 1 and the second terminal 3. In the present example, two resistive bodies are provided. The area of bonding between the resistive bodies 5, 5 and the respective first planar surfaces 11a, 13a is smaller than the area of the first planar surfaces 11a, 13a. The number of the resistive bodies 5, 5 is not limited to two. Further, the first terminal 1 and the second terminal 3 have hole portions 1a, 3a formed therethrough from the first planar surfaces 11a, 13a to the second planar surfaces 11b, 13b. Further, a support column member 6 is provided between the first terminal 1 and the second terminal 3. The support column member 6 is disposed similarly to the resistive bodies 5, 5. In FIGS. 1AA, 1AB, 1AC and B, a substrate (insulating substrate) 21 is interposed between the support column member 6 and the second terminal 3. The substrate 21 is a flexible substrate made of an insulating material, such as resin.

The substrate 21 has a voltage detection signal-extracting terminal 23 formed thereon. On an upper surface (front surface) 21a of the substrate 21, a region AR1 wider than a lower end surface of the support column member 6 is formed, for example. In the region AR1, a circular first electrode portion 27a is formed, for example, to which the lower end surface of the support column member 6 is connected. On the other hand, on the lower surface (back surface) 21b side of the substrate 21, a circular second electrode portion 27b is formed, for example, which is connected to the second terminal 3. The first electrode portion 27a and the second electrode portion 27b are insulated from each other by a part of the substrate 21 in the thickness direction thereof.

Further, on the upper surface (front surface) 21a of the substrate 21, first voltage detection terminals 31a, 31b (of which one, such as 31b, is a terminal for back-surface noise removal) for extracting a voltage detection signal from the first electrode portion 27a, and a part of a second voltage detection terminal 33a are formed. The first voltage detection terminals 31a, 31b are electrically connected to the voltage detection signal-extracting terminal 23 at a position toward the edge of the substrate 21, for example.

When the substrate 21 is viewed from the lower surface (back surface) 21b side, the second electrode portion 27b is formed and a second voltage detection terminal 33b connected thereto is provided. The second voltage detection terminal 33b is routed to the edge of the substrate 21 and is connected to a second pad 33b-1.

The second voltage detection terminals 33a, 33b are connected by a via (such as solder) formed from top to bottom, in the thickness direction, of the substrate 21, at corresponding in-plane positions of a first position 33a-1 and a second position 33b-1.

The first voltage detection terminals 31a, 31b are electrically connected to the first terminal 1 via the support column member 6. The second voltage detection terminal 33a is electrically connected to the second terminal 3.

Thus, on the substrate 21, the first voltage detection terminal 31a for the first terminal 1 side, the second voltage detection terminal 33a for the second terminal 3 side, and the voltage detection signal-extracting terminal 23 (connector 41) are formed.

With the above-described configuration, it is possible to extract a voltage signal on the first terminal 1 side and a voltage signal on the second terminal 3 side from the connector 41.

The resistive bodies 5, 5 are connected to the first terminal 1 and the second terminal 3 by soldering, for example. The support column member 6 is connected to the first terminal 1 and to the first electrode portion 27a of the substrate 21 by soldering, for example. Alternatively, provisional fixing holes or the like may be formed in the first terminal 1 and the second terminal 3, and the resistive bodies 5, 5 and the support column member 6 may be provisionally fixed therein, so that the resistive bodies 5, 5 and the support column member 6 can be fixed when a mounting structure is fabricated as will be described below.

The first terminal 1 and the second terminal 3 are formed from a metal material, such as Cu. The resistive bodies 5, 5 are formed from a resistive material, such as an Mn—Cu alloy. The support column member 6 is formed from a metal material, such as Cu. The materials are not limited to those mentioned above.

The support column member 6 is formed of a metal material such as Cu, and is therefore able to maintain a strength as a support column for supporting the first terminal 1 and the second terminal 3. Further, by interposing the insulating substrate 21 on the support column member 6, it is possible to ensure insulation between the first terminal 1 and the second terminal 3. In addition, with the electrode 27 on the substrate 21, it is possible to perform connection to the first terminal 1 and the second terminal 3 using solder, for example.

Further, because the support column member 6 is formed of metal material, it is possible, by forming a wire electrically connected to the support column member on the substrate, to accurately detect an electric current that flows between the first terminal 1 and the second terminal 3.

### (Method for Manufacturing Shunt Resistor)

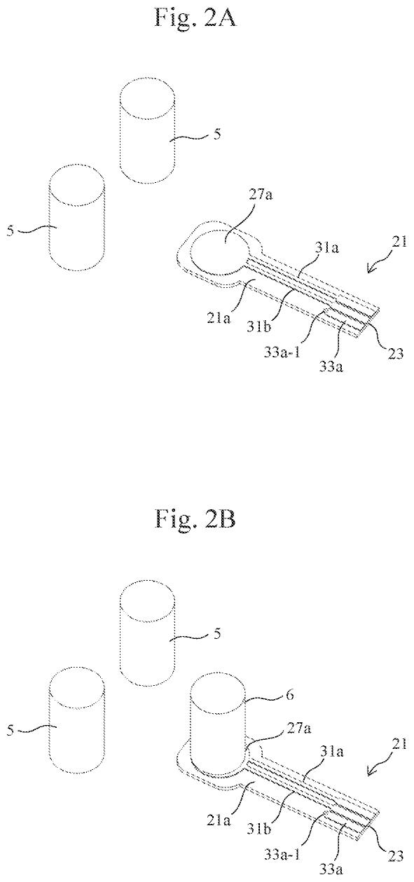

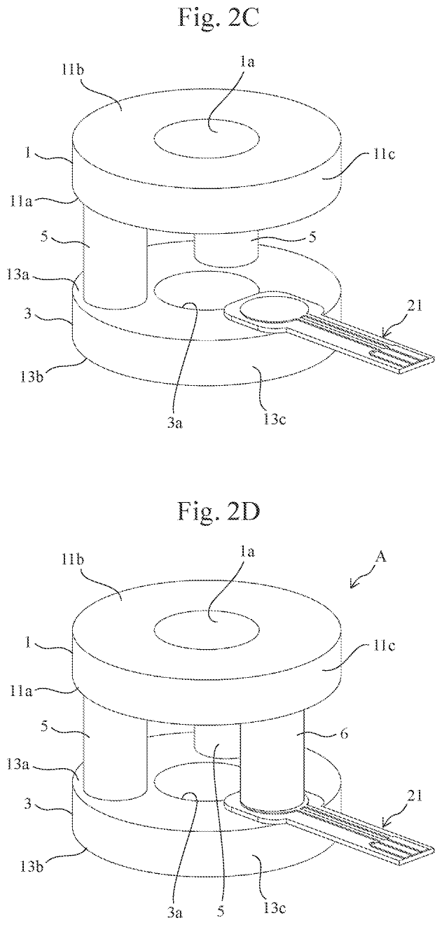

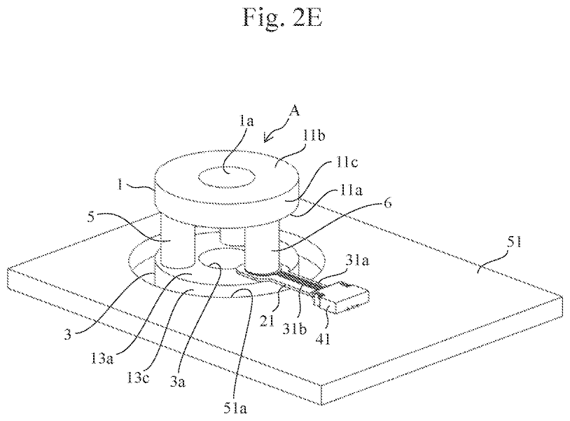

Next, with reference to FIG. 2A to FIG. 2E, a method for manufacturing the shunt resistor described above will be described. As illustrated in FIG. 2A, the columnar resistive bodies 5, 5 and the substrate 21 are prepared. As illustrated in FIG. 2B, the support column member 6 is connected to the first electrode portion 27a of the substrate 21 using solder, for example. As illustrated in FIG. 2C, the first terminal 1 and the second terminal 3 are prepared, and the columnar resistive bodies 5, 5 and the substrate 21 are disposed between the first terminal 1 and the second terminal 3. As illustrated in FIG. 2D, the support column member 6 is provided between the substrate 21 and the first terminal 1, and is fixed between the first terminal 1 and the substrate 21. These members may be fixed using an electrically conductive adhesive agent, for example. Thus, the shunt resistor A can be formed. As illustrated in FIG. 2E, the shunt resistor A is disposed within an opening portion (through-hole) 51a formed in the mounting substrate 51. Further, the voltage detection signal-extracting terminal (connector 41), which is the extracting portion for the first voltage detection terminal 31a and the second voltage detection terminal 33b formed on the substrate 21, can be connected to external cables (not illustrated) and the like on the mounting structure.

### (Shunt Resistor Mounting Structure)

Next, the details of a shunt resistor mounting structure (fixing structure) will be described.

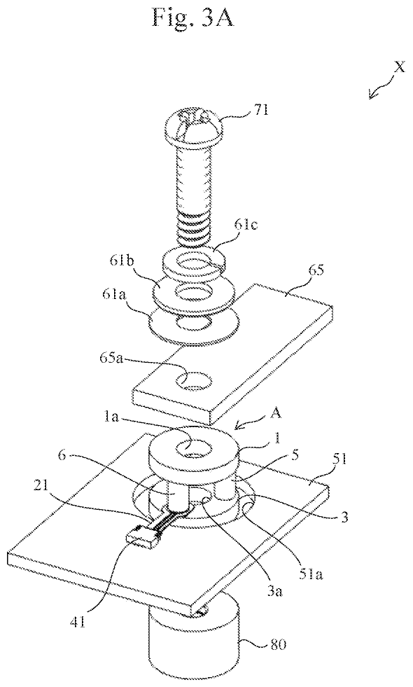

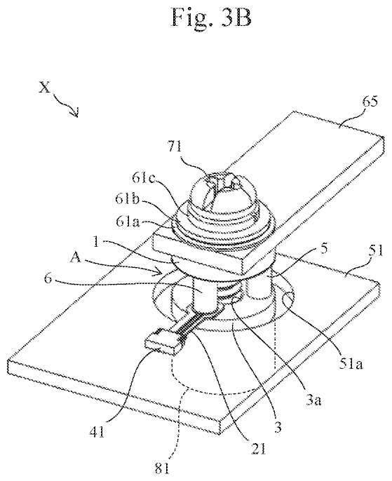

FIG. 3A is an exploded perspective view illustrating the shunt resistor mounting structure, and FIG. 3B is a perspective view illustrating the shunt resistor mounting structure. As illustrated in FIG. 3A and FIG. 3B, the shunt resistor mounting structure X is configured as follows.

In the foregoing, an example has been described in which the resistive bodies 5 and the support column member 6 are bonded using solder and the like. In the following, the resistive bodies 5 and the support column member 6 are initially provisionally fixed between the first terminal 1 and the second terminal 3, and are then fixed by the fixing structure.

The shunt resistor A with the resistive bodies 5 and the support column member 6 provisionally fixed between the first terminal 1 and the second terminal 3, the mounting substrate 51, and a power module terminal base (or a busbar; hereafter referred to as “terminal base”) 80 are screwed together with a screw 71 screwed into the terminal base 80 via a through-hole 65a formed in the busbar 65, a first through-hole 1a and a second through-hole 3a formed in the first terminal 1 and the second terminal 3 of the shunt resistor A, and the opening portion 51a formed in the mounting substrate 51. A nut, not illustrated, is disposed on the terminal base 80 side as a receiving side for the screw 71. Numerals 61a to 61c designate exemplary washers provided on the busbar 65. By tightening the screw 71, it is possible to fabricate the mounting structure X of a current detection device using the shunt resistor, as illustrated in FIG. 3B.

As described above, according to the present embodiment, it is possible to reduce the size of the resistor. Further, it is possible to achieve both strength and size reduction of the resistor. In addition, it is possible to suppress the influence of the noise of induced electromotive force generated by a magnetic flux due to an electric current being measured.

### Second Embodiment

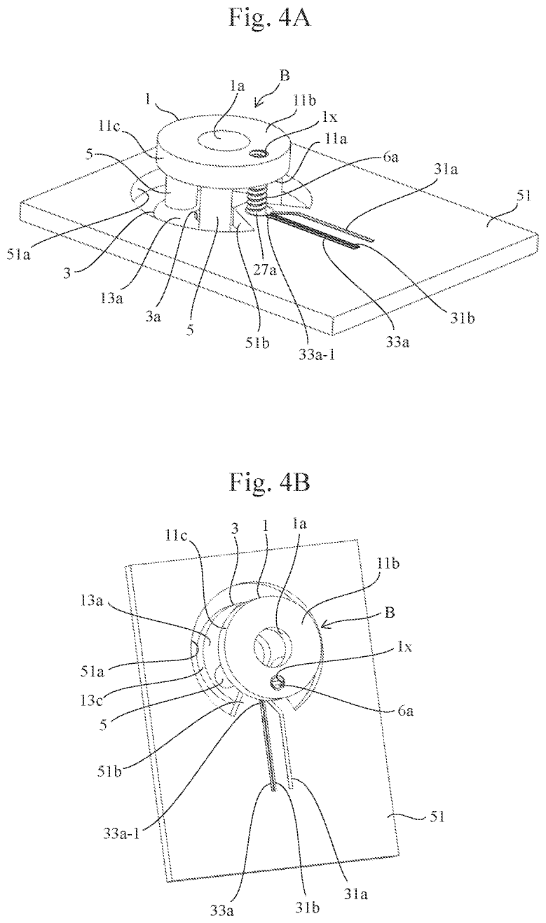

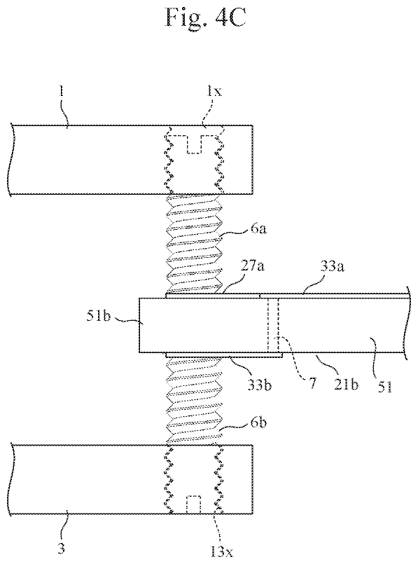

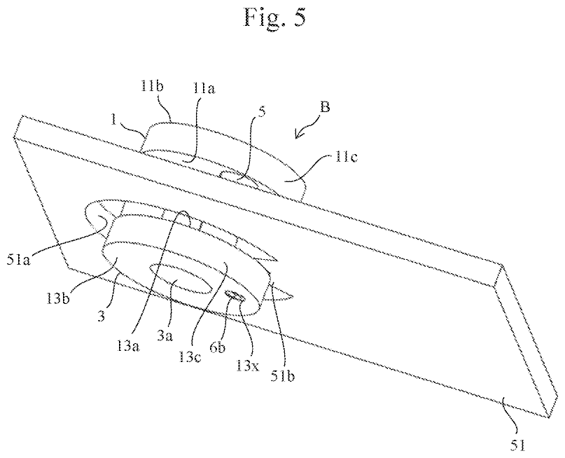

A second embodiment of the present invention will be described. Reference may also be made, as appropriate, to FIGS. 1AA, 1AB, 1AC and FIG. 1B referred to in the first embodiment. FIG. 4A and FIG. 4B are perspective views illustrating a configuration in which a shunt resistor B according to the present embodiment is attached to the mounting substrate 51. FIG. 4A is a view from diagonally above, and FIG. 4B is a perspective view from above. FIG. 4C is a cross sectional view illustrating a configuration in which the shunt resistor according to the present embodiment is attached to the mounting substrate. FIG. 5 is a perspective view from diagonally below of the configuration in which the shunt resistor B according to the present embodiment is attached to the mounting substrate 51.

In the second embodiment of the present invention, the support column member 6 has a metal screw structure, for example. As illustrated in FIG. 4A, FIG. 4B, and FIG. 4C, the first terminal 1 has a first screw hole 1x formed therein. A first support column member 6a having a screw structure is screwed into the first screw hole 1x and fixed therein.

On the other hand, as illustrated in FIG. 4C and FIG. 5, the second terminal 3 also has a second screw hole 13x formed therein. A second support column member 6b having a screw structure is screwed into the screw hole 13x and fixed therein, separately from the first support column member 6a.

The mounting substrate (insulating substrate) 51 is interposed between the first support column member 6a and the second support column member 6b. The mounting substrate 51 is sandwiched from both sides between the ends of the first support column member 6a and the second support column member 6b, whereby the mounting substrate 51 is fixed.

On the mounting substrate 51, the first voltage detection terminal 31a connected to the first terminal 1, the second voltage detection terminal 33b connected to the second terminal 31, and the voltage detection signal-extracting terminal (not illustrated) are formed.

On the upper surface (front surface) 21a of the substrate 51, the first voltage detection terminals 31a, 31b (of which one, such as 31b, is a noise removal terminal) for extracting a voltage detection signal from the first electrode portion 27a, and a part of the second voltage detection terminal 33a are formed. The first voltage detection terminals 31a, 31b are electrically connected to the voltage detection signal-extracting terminal at a position toward the edge of the mounting substrate 51, for example.

On the lower surface (back surface) 21b side of the mounting substrate 51, the second voltage detection terminal 33b is provided on the back surface 21b.

The first voltage detection terminals 31a, 31b are electrically connected to the first terminal 1 via the first support column member 6a. The second voltage detection terminal 33b is electrically connected to the second terminal 3 via the second support column member 6b.

The second voltage detection terminals 33a, 33b are connected by a conductive via 7 disposed through the mounting substrate 51 from top to bottom in the thickness direction.

With the above-described configuration, it is possible to extract a voltage signal on the first terminal 1 side and a voltage signal on the second terminal 3 side from the connector 41 (FIG. 2E).

As described above, according to the present embodiment, the support column member 6 having a screw structure is configured of the first support column member 6a connected to the first terminal 1 and the second support column member 6b connected to the second terminal 3. The first support column member 6a and the second support column member 6b have their distal ends respectively abutting the front surface 21a of the substrate and the back surface 21b of the substrate. The first support column member 6a and the second support column member 6b are insulated from each other by the mounting substrate 51 of insulating material, and are not electrically connected to each other.

It is noted that, with respect to the shunt resistor B having the screw-structured first support column member 6a and second support column member 6b, it is also possible to form a mounting structure similar to the structure illustrated in FIG. 3A, FIG. 3B.

### Third Embodiment

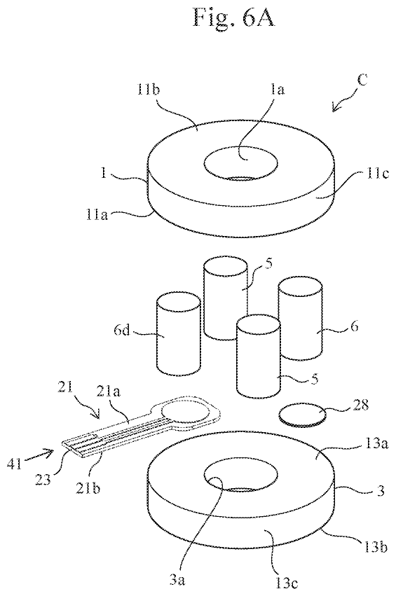

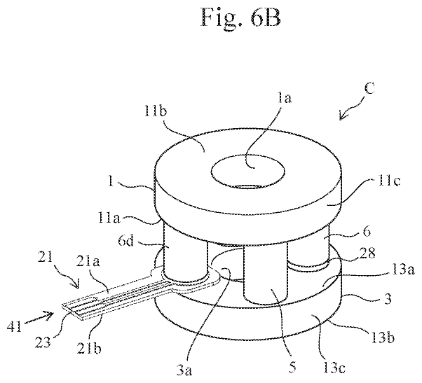

FIG. 6A is an exploded perspective view illustrating a configuration example of a shunt resistor C according to a third embodiment of the present invention. FIG. 6B is a perspective view of the shunt resistor C. The configuration illustrated in FIG. 6A and FIG. 6B, in order to suppress the influence of the noise of induced electromotive force of the voltage detection terminals more, includes a support column member 6 for increasing strength and a voltage-detecting support column member 6d to which the substrate 21 is attached in the same way as described above. The voltage-detecting support column member 6d is preferably disposed in an appropriate position in consideration of the mounting structure and the like. Thus, it is possible to provide the support column members 6, 6d in positions suitable for their respective purposes.

The support member 6 for increasing strength needs to be fixed while insulating the first terminal 1 and the second terminal 3. Accordingly, a circular solder-fixing pattern 28 is provided, for example. The solder-fixing pattern 28 comprises an insulating substrate 28 having the same thickness as that of the substrate 21, and has circular electrodes on both sides, for example. The circular electrodes are provided for the sole purpose of fixing the soldering support member 6 on the second terminal 3 side or the first terminal 1 side by soldering, and are insulated from each other by the insulating substrate 28. The insulating substrate 28 may be interposed between the support column member 6 and the first terminal 1.

### Fourth Embodiment

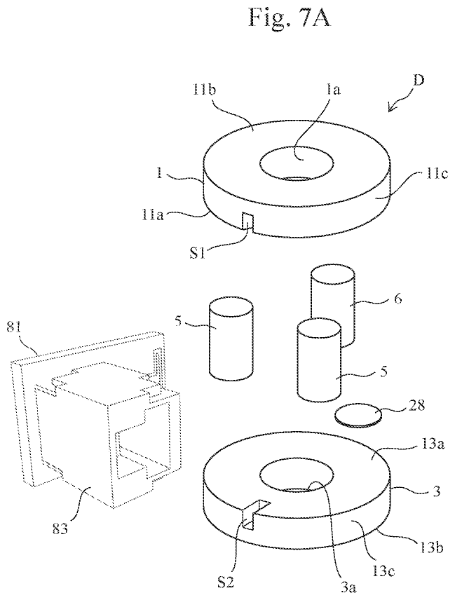

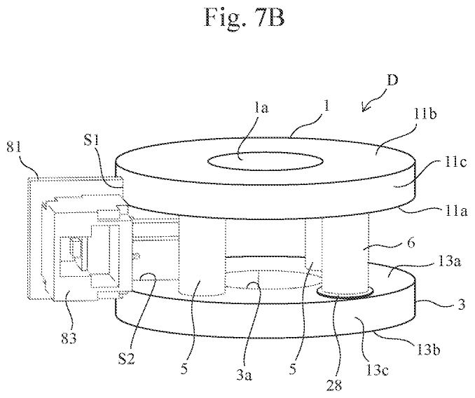

FIG. 7A is an exploded perspective view illustrating a configuration example of a shunt resistor D according to a fourth embodiment of the present invention. FIG. 7B is a perspective view of the shunt resistor D. The configuration illustrated in FIG. 7A and FIG. 7B is provided with a voltage detection signal-extracting substrate 81 separately, unlike in the first to third embodiments. The voltage detection signal-extracting substrate 81 is fixed by, for example, inserting the voltage detection signal-extracting substrate 81, which is fitted with a voltage detection signal-extracting circuit 83, into slits S1, S2 respectively provided on the opposing sides of the first terminal 1 and the second terminal 3.

Thus, the voltage detection signal-extracting substrate 81 fitted with the voltage detection signal-extracting circuit (not illustrated) and the connector 83 for exchanging signals therewith is provided separately. When such structure is preferable, the configuration of the fourth embodiment may be used. In this case, the printed substrate 21 is not required. By providing a plurality of alternatives, the effect of an increase in the degree of design freedom can be obtained. The support member 6 for increasing strength needs to be fixed while insulating the first terminal 1 and the second terminal 3. Accordingly, the circular solder-fixing pattern 28 is provided, for example. The solder-fixing pattern 28 comprises the insulating substrate 28 having the same thickness as that of the substrate 21, and has circular electrodes on both sides, for example. The circular electrodes are provided for the sole purpose of fixing the soldering support member 6 on the second terminal 3 side or the first terminal 1 side, and are insulated from each other by the insulating substrate 28. The insulating substrate 28 may be interposed between the support column member 6 and the first terminal 1.

In the foregoing embodiments, the configurations and the like that have been illustrated are not intended to be limiting and may be modified, as appropriate, as long as the effects of the present invention can be obtained. Also, various changes may be made and implemented, as appropriate, within the scope of the purpose of the present invention. The constituent elements of the present invention may be optional, and an invention provided with an optional configuration is also included in the present invention.

### INDUSTRIAL APPLICABILITY

The present invention may be utilized in a shunt resistor.

All publications, patents, and patent applications cited in the present Description are incorporated herein by reference in their entirety.

1. A shunt resistor comprising:
a first terminal and a second terminal each made of an electrically conductive metal material and having a first planar surface and a second planar surface,
the respective first planar surfaces of the first terminal and the second terminal opposing each other; and
a resistive body and a support column member each connected to the respective first planar surfaces and connecting the first terminal and the second terminal, the support column member being made of a metal material,
wherein an area of bonding between the resistive body and the support column member and the respective first planar surfaces is smaller than an area of the first planar surface, and the first terminal and the second terminal each have a hole portion formed so as to penetrate therethrough from the first planar surface to the second planar surface.

2. The shunt resistor according to claim 1, comprising an insulating substrate interposed between the support column member and the first terminal or the second terminal.

3. The shunt resistor according to claim 2, wherein the insulating substrate has a wiring pattern, and the support column member and the wiring pattern are connected.

4. The shunt resistor according to claim 1, wherein the support column member has a screw structure.

5. A mounting structure for the shunt resistor according to claim 1, the mounting structure comprising a fixing means penetrating through the hole portions and fixing the first terminal and the second terminal together.
